(19) United States
(12) Patent Application Publication
(10) Pub. No.: US 2012/0050856 A1
(43) Pub. Date: Mar. 1, 2012

(54) APPARATUS AND PROCESS FOR STEREOSCOPIC VISION

(75) Inventor: Peter Shintani, San Diego, CA (US)

(73) Assignee: Sony Corporation, Tokyo (JP)

(21) Appl. No.: 12/874,042

(22) Filed: Sep. 1, 2010

(51) Int. Cl. G02B 27/22

(52) U.S. Cl. 359/464; 250/232; 250/201.1

(57) ABSTRACT

Shuttered eyewear comprising: a frame; a right eye shutter supported by the frame; a left eye shutter supported by the frame; and a sensor arranged to detect light passing through the right eye shutter, the left eye shutter, or both.

### FIELD

The present patent document relates to apparatus and processes for stereoscopic vision.

### BACKGROUND

The human eye can perceive depth. Depth is the third dimension of our visual capability. We perceive depth because each of our eyes views an object from a slightly different vantage point. The human brain combines the images received independently from each eye to enable the perception of depth. However, when looking at an image on a screen such as a monitor, television, or other flat device, each eye sees the same image and consequently, the brain correctly perceives no depth.

Many people in the entertainment industry believe that movies, films, and other entertainment lack an element of realism because they appear two-dimensional in a world we otherwise always perceive as three-dimensional. Thus, a method or process to add the perception of depth to images shown on flat screens such as televisions, monitors, and movie screens has been sought for some time. The ability to allow visualization of depth from a two-dimensional display is sometimes referred to as stereoscopy.

One method of facilitating the perception of depth from an image on a two-dimensional screen is to show two slightly different images, each one visible only to one eye. If this is performed correctly, each eye sees a different image which appears to come from a slightly different vantage point and the brain perceives a depth to the object, just as it would when viewing the actual object in real life. However, there are numerous issues involved in rendering the separate images so that they appear to come from a slightly different vantage point. First, the images must be constructed to be identical in every way but appear to be viewed from a slightly different vantage point. Second, each of the eyes must be prevented from seeing any part of the image intended for the other eye. The former problem is eliminated through the use of computer technology and sophisticated camera techniques. The latter problem is sometimes referred to as cross-talk and is still an existing problem. If too much cross-talk occurs between the images i.e., the left eye sees too much of the image intended for the right eye and vice versa, the brain will not correctly perceive the three-dimensional effect.

Numerous methods have been developed to isolate the images so that each eye sees a different image and there is as little interference or cross-talk as possible from the other image. These methods can be subdivided in to active and passive methods of stereoscopy.

One common passive method used to allow each of our eyes to see a separate image from the same display is through the use of polarization. For example, two images may be simultaneously projected each with a separate polarization. The viewer may then use a special pair of viewing glasses that only allow light with a specific polarization direction to be transmitted to each eye. As an example, the lens on the glasses covering the right eye may only allow vertically polarized light to be transmitted to the right eye while the lens on the glasses covering the left eye may only allow horizontally polarized light to be transmitted to the left eye. In this way, two separate images may be shown to each eye. Numerous other passive methods exist including methods based on color instead of polarization such as anaglyphs, Colorcode 3D, and Chromadepth.

Passive methods of stereoscopy have problems associated with maintaining the polarization of the light, color depth, and the sharpness of the images. Active methods of stereoscopy may ameliorate or even eliminate these problems.

One active method of stereoscopy shows separate images on the screen in rapidly alternating successive fashion while the user views the screen through shuttered eyewear. Shuttered eyewear is worn by the viewer and successively blocks or passes light through in synchronization with the images on the display. When the image intended for the right eye is being projected the left shutter on the shutter eyewear blocks the light to the left eye and the right shutter on the shuttered eyewear allows the light to pass into the right eye. The projected image is then changed to the image intended for the left eye and the left and right shutters on the shuttered eyewear swap states so that light passes to the left eye and light is blocked to the right eye. This process may be rapidly repeated and due to humans' inability to detect frequencies above about 15 Hertz, the shuttering may be undetectable. When the separate images are shifted correctly in vantage point, the brain will perceive a three-dimensional image as each eye only sees the unique image intended for that particular eye.

While shuttered eyewear provides a viable method to allow each eye to see separate images, a number of problems remain with current designs. For example, cross-talk still remains an issue with current shuttered eyewear designs. The shutter on each side of the shuttered eyewear separately covering an individual eye cannot instantaneously allow light to pass or block light from passing. Consequently, there is some delay between when a command to switch the state of the shutter is given and when the state of the shutter actually has completely switched. If not taken into consideration, the delay or lag time potentially creates cross-talk.

As an example, a stereoscopic viewing system may be in a state where an image is being projected that is meant for viewing by the left eye and the viewer is wearing shuttered eyewear that are in a state where the light is fully passing to the left eye and completely blocked to the right eye. At this moment the image cannot be switched to the image meant for viewing by the right eye until the shuttered eyewear has first blocked a substantial portion of the light meant for the left eye. Otherwise, the left eye will see the image meant for the right eye and the three-dimensional effect will be distorted. Accordingly, a substantial portion of light may be blocked to both eyes while the image is being switched. The problems with cross-talk create a complicated synchronization problem between the shuttered eyewear worn by viewer and the display system alternating between the images intended for the left or right eye.

Methods to try and solve the synchronization problem between shuttered eyewear and their respective display have been proffered. However, these methods fall short of adequately solving the synchronization problem. U.S. patent application Ser. No. 09/776,185 to Robinson et al. (the “'185 application”) discloses “transmitting infrared light to the eyewear” to synchronize and coordinate the shutters. (Abstract) The '185 application further discloses including “a delay to accommodate the switching time and latency of the . . . eyewear and signal transmission.”(Abstract)

Existing systems, including the one disclosed by the '185 application, fail to precisely determine the duration of the delay and precisely when the delay should occur. Furthermore, the existing systems do not take into account changes in the response of the shuttered eyewear and/or the display system as they transition from a transient state to a steady state condition. In addition, the current synchronization methods do not take into account changes in the environment that may affect the timing of the stereoscopic system.

In addition to cross-talk, the synchronization problem in stereoscopic systems that use shuttered eyewear is further hampered by the effect of the shuttered eyewear on brightness. Because the human brain cannot detect frequencies much greater than about 15 Hz, switching the images above 15 Hz will begin to remove the brains ability to detect the flicker that seems intuitively to be a problem with periodically blocking light from passing to your eyes using shuttered eyewear. However, while the flicker may be reduced or eliminated, the longer total time the light is blocked, the fewer photons that will strike the retina of the eye and the dimmer the image appears to the viewer. Consequently, the operation of the shuttered eyewear significantly reduces the perceived brightness of the images by the user. Therefore, it is advantageous to minimize the amount of time the light is blocked by the shuttered eyewear. Because trying to reduce the time the light is blocked has the effect of potentially increasing cross-talk, a dichotomy exists between brightness and cross-talk that increases the need to precisely synchronize the shuttered eyewear and the system displaying the images intended for the left and right eye.

In addition to the delays created by the latency of the shutter on the shuttered eyewear transitioning from a transmissive state to a non-transmissive state, other delays may exist in the stereoscopic system. These delays may include delays due to transmission and reception of signals; delays in switching between an image intended for the right eye and an image intended for the left eye; and delays due to calculation or processing times. All of these delays may be transient, which further increases the synchronization problem.

Other latency and/or asynchronous delays may be added to the system by the environment and/or changes in the environmental surroundings of the stereoscopic system. Displays such as liquid crystal displays (LCDs) or plasma screens may create large amounts of heat. The heat given off by the displays may affect the surrounding temperature of the stereoscopic system and thus affect synchronization. Other factors such as temperature changes caused by a large number of viewers or a heating and/or cooling system may also affect synchronization.

Because of the sensitivity the synchronization of stereoscopic systems may have on their performance, even the smallest improvement in synchronization may translate into a substantially better user experience.

### SUMMARY OF THE EMBODIMENTS

In view of the foregoing, an object according to one aspect of the present patent document is to provide an improved apparatus and process for synchronizing a stereoscopic system. Preferably the apparatus and process address, or at least ameliorate one or more of the problems described above. To this end, shuttered eyewear is provided; the shuttered eyewear comprises: a frame; a right eye shutter supported by the frame; a left eye shutter supported by the frame; and a sensor arranged to detect light passing through the right eye shutter, the left eye shutter, or both.

In another embodiment, the shuttered eyewear further comprises a transmitter. The transmitter may be used to transmit information about detected light passing through the right eye shutter, the left eye shutter, or both of the shutters on the shuttered eyewear.

In yet another embodiment, the timing of the right eye shutter, the left eye shutter or both shutters is modified based on information from the sensor. This may be done by modifying a synchronization signal being sent to the shuttered eyewear, or done internally by the shuttered eyewear.

In other embodiments, the sensor is connected and oriented to the shuttered eyewear in different configurations. For example, the sensor may be connected to the frame on a proximal side with respect to the face and oriented to detect light without reflection passing through either the left eye shutter or the right eye shutter. In another embodiment, the sensor is oriented to detect light reflected from an eyeball of a person wearing the shuttered eyewear.

In another embodiment, the sensor is a photo diode. However, the sensor may be any photoelectric device.

In yet another embodiment, the synchronization of the shuttered eyewear involves the use of a calibration image.

In another embodiment, a system for stereoscopic viewing is disclosed, the system comprising: a display; and shuttered eyewear designed to detect light from the display that passes through the shuttered eyewear.

In another embodiment of a system for stereoscopic viewing, the information from the detected light that passes through the shuttered eyewear is used to synchronize the display and the shuttered eyewear. In certain implementations of this embodiment, the information is transmitted from the shuttered eyewear to the display. In other embodiments, the synchronization is controlled by a microprocessor.

In a further embodiment, the shuttered eyewear of the system includes a sensor mounted to the shuttered eyewear. The sensor is used to detect the light that passes through the shuttered eyewear.

In another embodiment, a method of operating shuttered eyewear is disclosed, the method comprising the steps of: opening a first eye shutter; closing a first eye shutter; opening a second eye shutter; closing a second eye shutter; and sensing a light that passed through either the first eye shutter or the second eye shutter or both.

In another embodiment, the method of operating a shuttered eyewear further comprises the step of using information from the sensed light to synchronize the left eye shutter, the right eye shutter, or both.

In yet another embodiment, the method of operating a shuttered eyewear further comprises the step of transmitting information about the sensed light from the shuttered eyewear to the display.

In another embodiment, the shuttered eyewear are placed within a calibration station during the sensing light step.

In yet another embodiment, the sensed light from the sensing step is derived from a calibration image.

In an additional embodiment, the left eye shutter, right eye shutter, or both are synchronized through the additional step of sending a modified synchronization signal from a display to the shuttered eyewear.

As described more fully below, the apparatus and processes of the embodiments permit the efficient synchronization of stereoscopic systems. Further aspects, objects, desirable features, and advantages of the apparatus and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 illustrates an embodiment of a stereoscopic system.

FIG. 2 illustrates an isometric view of an embodiment of shuttered eyewear.

FIG. 3 illustrates a side view of shuttered eyewear.

FIG. 4 illustrates a view of one embodiment of shuttered eyewear with multiple sensors.

FIG. 5 illustrates an embodiment of a stereoscopic system.

FIG. 6 illustrates an embodiment of a synchronization signal received by shuttered eyewear.

FIG. 7 illustrates shuttered eyewear mounted in a calibration docking station.

### DETAILED DESCRIPTION OF THE EMBODIMENTS

Consistent with its ordinary meaning, the term “shuttered eyewear” is used herein to refer to any eyewear that blocks or passes light through to each eye. “Shuttered eyewear” includes glasses, goggles, spectacles, helmets, or any other form of eye covering that is adapted to switch between a transmissive state and a non-transmissive state. The shuttered mechanism may preferably be a liquid crystal but “shuttered eyewear” includes other types of eyewear with different shutter mechanisms for example a mechanical shutter. The transmissive state of the shuttered eyewear may be affected by polarization, color, obstruction or any other method for changing the ability of a substance to allow light to pass.

Consistent with its ordinary meaning, the term “stereoscopic system” is used herein to refer to any system that individually displays separate images to the left and right eyes. “Stereoscopic system” includes systems that display separate images to individual eyes to simulate a third dimension and for any other reason. By way of non-limiting example, “stereoscopic system” includes both active and passive systems based on polarization, color, shuttered eyewear, or other technologies or combinations of technology.

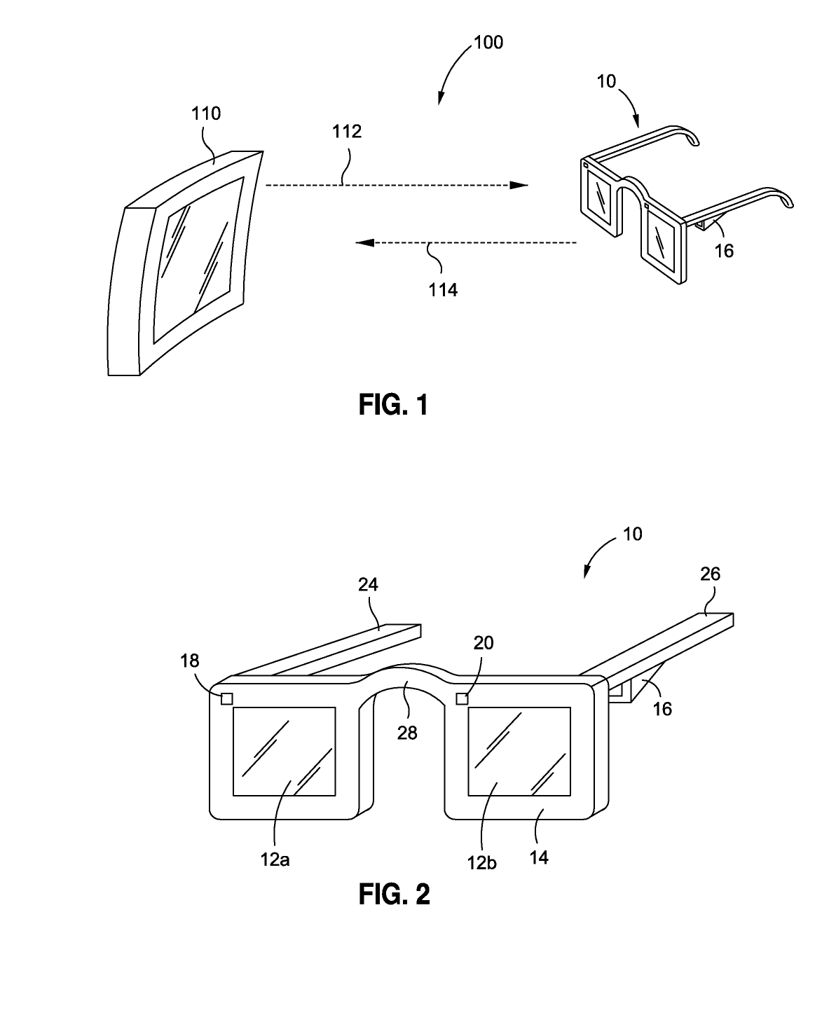

FIG. 1 illustrates an embodiment of a stereoscopic system 100. The embodiment of FIG. 1 further includes a display 110 and shuttered eyewear 10.

In stereoscopic systems, such as the stereoscopic system 100 shown in FIG. 1, the response speed of the display 110 and the response speed of the shuttered eyewear 10 may vary. These variations may be caused by numerous influences including production tolerances, ambient temperature changes, or transient states of operation. In order to minimize cross-talk and maximize brightness, the synchronization between the shuttered eyewear 10 and the display 110 must be optimized for the entire throughput of the stereoscopic system 100. To this end, the present patent document teaches the use of a sensor 16, to sense the synchronization of the shuttered eyewear 10. In a preferred embodiment, the sensor 16 detects light passing through the shuttered eyewear 10 and provides feedback information 114 about the detected light into the stereoscopic system 100 to allow the synchronization to be optimized. The stereoscopic system 100 may adjust the synchronization signal contained in information 112 sent to the shuttered eyewear 10 based on the feedback information 114 the stereoscopic system 100 receives from the sensor 16.

FIG. 2 illustrates an isometric view of an embodiment of shuttered eyewear 10. The embodiment of shuttered eyewear 10 shown in FIG. 2 further comprises a frame 14, a right eye shutter 12a, and a left eye shutter 12b. In FIG. 2, the frame 14 includes frame nose piece 28 and frame arms 24 and 26 respectively. While the embodiment shown in FIG. 2 depicts a classic glasses configuration, the frame 14 may be made in any configuration. In FIG. 2, the frame 14 is illustrated to encase the right and left eye shutters 12a and 12b, however, any style or kind of frame 14 may be used. For example, the frame 14 may only attach to the top of the right and left eye shutter 12a and 12b or the frame 14 may be intermittently attached. The frame 14 may be round or oval or any other shape instead of square. Any style or shape frame 14 may be used for the purpose of supporting the right and left eye shutters 12a and 12b. Furthermore, the frame 14 may be made from any material suitable for frames including plastic, metal, rubber, ceramic, wire, or any other material that may provide support for the right and left eye shutters 12a and 12b.

The eye shutters 12a and 12b are preferably made of liquid crystal or with a layer of liquid crystal. The layer of liquid crystal is normally transparent but becomes dark when a voltage is applied. Of course, the inverse may be possible in which the liquid crystal layer is inherently dark and becomes transparent when a voltage is applied. The liquid crystal may become dark and block all light or may block light by changing its polarization thus blocking out all but a specifically polarized light. In other embodiments, other technologies may be used for the right eye shutter 12a and left eye shutter 12b, including but not limited to mechanical shutters, color based shutters, or other substances or films that can rapidly change between transmissive and non-transmissive states.

In one embodiment as shown in FIG. 1, the shuttered eyewear 10 further comprises a sensor 16. The sensor 16 is capable of detecting light and/or an image that passes through the left eye shutter 12b, right eye shutter 12a, or both. FIG. 2 shows the sensor 16 mounted on the arm 26 of the frame 14, however, the sensor 16 may be mounted anywhere on the frame 14 including the frame nose piece 28, the frame arm 24, any part of the frame proximate the right and left eye shutters, or any other part of the frame 14.

The shuttered eyewear 10 may further comprise a communication receiving sensor 18. The communication receiving sensor 18 receives information 112 from the stereoscopic system 100. Preferably the information 112 is sent using infrared technology and the communication receiving sensor 18 is an infrared sensor. However, communication between the shuttered eyewear 10 and the rest of the stereoscopic system 100 may use any appropriate communication technology. For example, the information 112 may be sent using wireless protocols such as Bluetooth® or WiFi (IEEE 802.11). As a further example, other radio frequency (RF) or laser light may also be used to communicate between the shuttered eyewear 10 and the stereoscopic system 100. To this end, the communication receiving sensor 18 may be any appropriate sensor or antenna capable of accommodating the protocol used to transfer information 112 between the shuttered eyewear 10 and the stereoscopic system 100. For example, the communication receiving sensor 18 may be a Bluetooth® antenna, WiFi antenna, or some other appropriate antenna or sensor.

Because IR is often used in association with television remote controls and other media devices, in a preferred embodiment the IR transmissions to the shuttered eyewear 10 are designed to prevent interference with other transmission devices that are a part of the stereoscopic system 100, such as remote controls.

In other embodiments, the communication receiving sensor 18 may use a wired technology to communicate with the stereoscopic system 100. For example, instead of the IR sensor of the preferred embodiment, the communication receiving sensor 18 may be an Ethernet connection, serial connection, parallel connection, or any other connection commonly used for communication between devices.

Shuttered eyewear 10 may further comprise a transmitter 20. In one embodiment, the transmitter 20 communicates information 114 from the sensor 16 on the shuttered eyewear 10 back to the stereoscopic system 100. The stereoscopic system 100 may use the information 114 transmitted from the sensor 16 to adjust the synchronization of the shuttered eyewear 10. In a preferred embodiment, the stereoscopic system 100 adjusts the synchronization of the shuttered eyewear 10 by adjusting the synchronization signal sent in the information 112 to the shuttered eyewear 10.

The transmitter 20 preferably communicates using RF, however, similar to the communication receiving sensor 18, the transmitter 20 may use any wireless or wired technology to communicate including but not limited to Bluetooth®, WiFi, RF, laser or other wireless technologies. In addition and also similar to the communication receiving sensor 18, the transmitter 20 may use a wired technology to communicate such as Ethernet, serial or parallel connections or any other type of wired technology capable of allowing two devices to communicate.

The communication receiving sensor 18 and the transmitter 20 are shown in FIG. 2 mounted to the exterior of the frame 14. In a preferred embodiment where wireless communication is used, an exterior outwardly facing mounting position is preferred for the communication receiving sensor 18 and the transmitter 20. Mounting the communication receiving sensor 18 and the transmitter 20 on an outward facing surface of the shuttered eyewear 10 facilitates a more direct line of sight for communications. If a wired technology is used, the placement of the communication receiving sensor 18 and the transmitter 20 will not be as important. Accordingly, if a wire is used to allow communication with the shuttered eyewear 10, the communication receiving sensor 18 and the transmitter 20 may be relocated to other locations on the shuttered eyewear 10. For example, the communication receiving sensor 18 and the transmitter 20 may be located on the back of either of the frame arms 24 or 26.

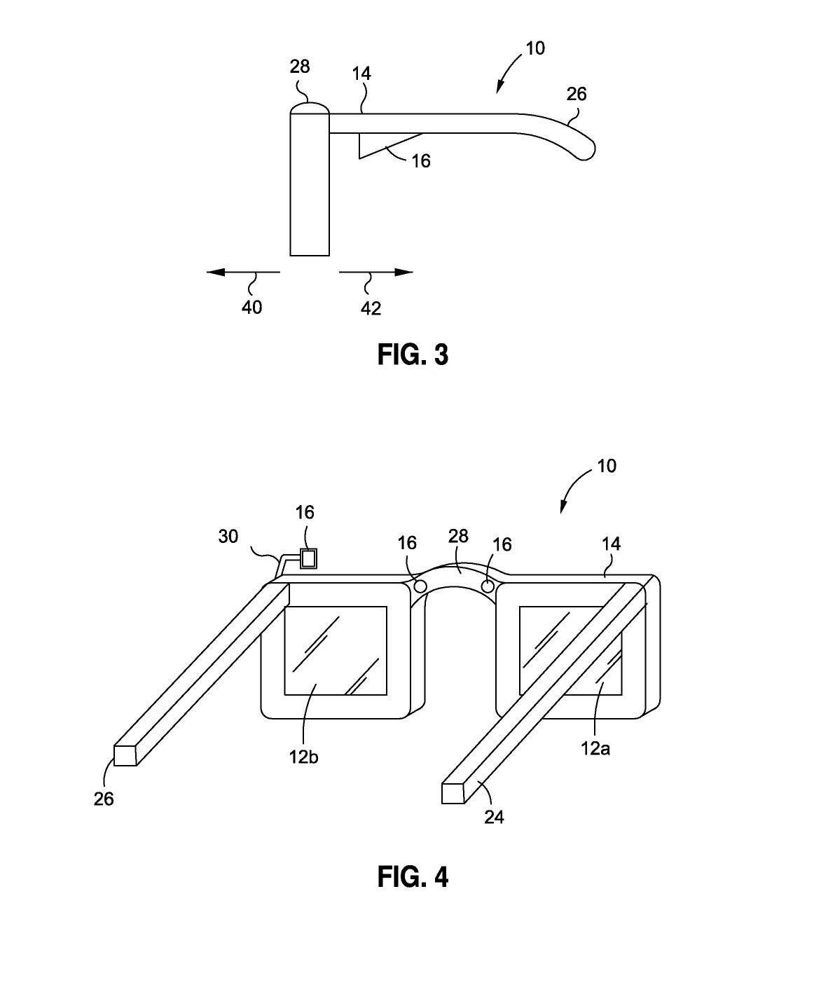

FIG. 3 illustrates a side view of one embodiment of shuttered eyewear 10. As shown in FIG. 3 for reference, the shuttered eyewear 10 may be divided by the relationship of the frame and the face of a user. As shown in FIG. 3, the shuttered eyewear 10 may be divided into proximal side 42 and distal side 40. Furthermore, and also for reference, arrow 40 shows a direction away from a user wearing shuttered eyewear 10 and arrow 42 shows a direction towards a user.

As shown in FIG. 3 and preferably, the sensor 16 is mounted on the proximal side 42 of the shuttered eyewear 10. In addition, the sensor 16 is preferably mounted so that it is pointing in a direction away from the face of a user. By mounting the sensor 16 on the proximal side 42 and pointing the sensor 16 away from the face of the user, the sensor 16 is able to receive light passing through right eye shutter 12a, left eye shutter 12b, or both, without reflection. However, the sensor 16 is not restricted to any specific location or orientation and the sensor 16 may be mounted on either the proximal side 42 or the distal side 40 of the shuttered eyewear 10. In addition, the sensor 16 may face towards or away from the face of the user.

FIG. 4 illustrates a view of one embodiment of shuttered eyewear 10 with multiple sensors 16. As can be seen in FIG. 4, the sensors 16 may be mounted on the proximal side 42 of the shuttered eyewear 10 facing towards the user. In such a configuration, the sensors 16 are designed to detect the light reflected from the user's eye(s). After the light passes through the right shutter 12a, the left shutter 12b, or both, a portion of the light will be reflected by the surface of the user's eye. The reflected light may be detected by the sensor 16 and used to further synchronize the stereoscopic system 100.

In addition, the sensor 16 may be mounted on the distal side 40 of the shuttered eyewear 10. If the sensor 16 is mounted on the distal side 40 of the shuttered eyewear 10, the sensor 16 may be facing toward the user and detect the reflected light from the surface of the distal side 40 of the shuttered eyewear 10. In such an embodiment, the sensor 16 may be arranged to detect the difference in reflected light between when one of the eye shutters 12a or 12b is blocking light and when one of the eye shutters is allowing light to pass.

If a sensor 16 is mounted on the distal side 40 of the shuttered eyewear 10, a sensor mount 30 may be used to appropriately position the sensor 16. The sensor mount 30 may similarly be used in other embodiments where a sensor 16 is mounted on the proximal side 42 of the shuttered eyewear 10. The sensor mount may be used to easily facilitate any mounting position or orientation for a sensor 16 on the frame 14. Accordingly, a sensor 16 may be better positioned.

The sensor mount 30 may be made of a bendable material such as rubber coated wire, malleable metal, or a thin strip of metal so that the position of a sensor 16 may be easily modified after mounting. Furthermore, the sensor mount 30 may be mechanically more sophisticated. For example, the sensor mount 30 may include fine adjustment mechanisms and locking mechanisms to allow accurate adjustment and locking.

As may be seen by FIG. 4, any number of sensors 16 may be used on the shuttered eyewear 10. FIG. 4 illustrates three separate sensors 16 but in other embodiments more or less may be used. In addition, different sensors 16 may be combined on the same shuttered eyewear 10. The shuttered eyewear 10 may have at least one sensor 16 responsible for detecting light intended for each individual eye. However in other embodiments, the shuttered eyewear 10 may only have one sensor 16 total. In one embodiment, shuttered eyewear 10 may have more than one sensor 16 responsible for detecting the light intended for an individual eye. In other embodiments, the shuttered eyewear 10 may have any combination of sensors 16 in any orientation or mounting position to detect the light intended for each individual eye. Preferably, the shuttered eyewear 10 has at least one sensor per eye.

In various different embodiments, the sensor(s) 16 may be a photo diode, light detector, light sensor, light probe, imaging array, image sensor, photoelectric device or any other device capable of detecting light or images. In addition, a sensor 16 may be an assembly of optics and a sensor to focus or image the light.

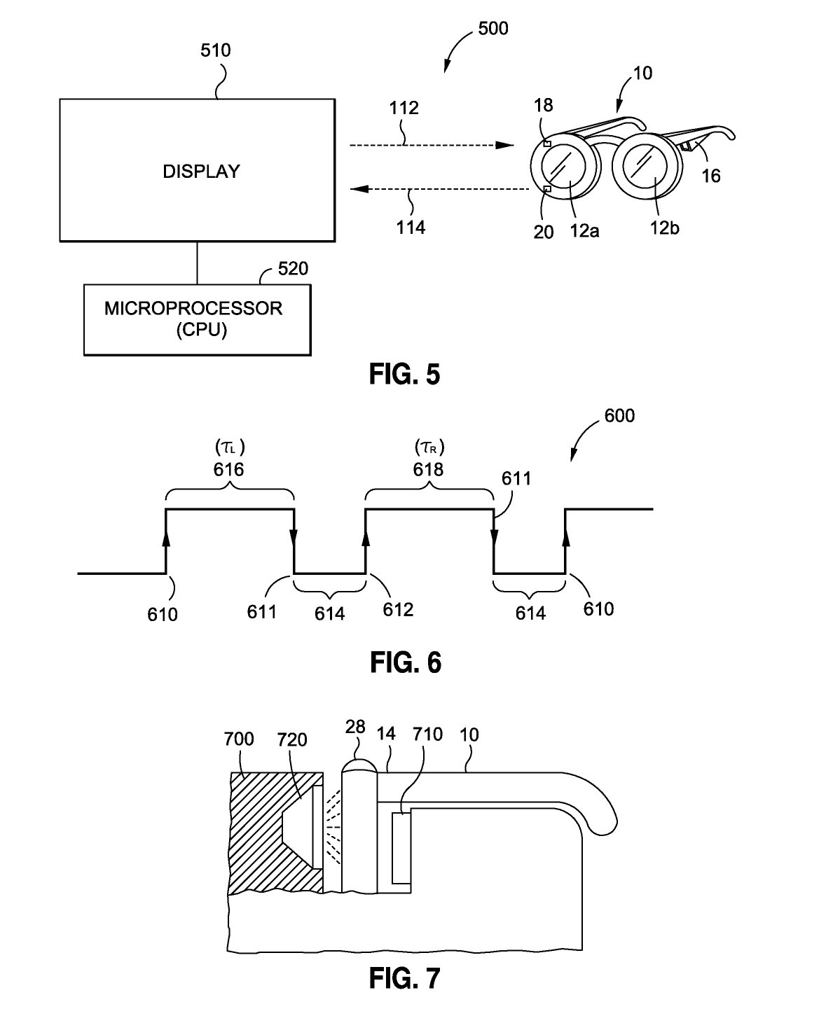

FIG. 5 illustrates an embodiment of a stereoscopic system 500 that includes a display 510, a microprocessor 520, and shuttered eyewear 10. The microprocessor 520 may be any electronic chip(s) capable of processing data for the stereoscopic system 500. For example, the microprocessor 520 may be a FPGA, ASIC, DSP, or any other chip capable of data handling. The microprocessor 520 may be physically located within the display or may be in a separate box that drives the display. For example, the microprocessor 520 may be part of a computer that is in communication with the display 510.

The operation of an embodiment, such as the one shown in FIG. 5, will subsequently be discussed. The microprocessor 520 drives the display 510 and instructs the display 510 to display an image intended for viewing by the left eye. The microprocessor, either directly or through another device such as the display, sends information 112 to the shuttered eyewear 10. The information 112 includes a signal instructing the shuttered eyewear to open the left eye shutter 12b. After a period of time, the microprocessor 520 instructs the display 510 to change the image to an image intended for viewing by the right eye. The microprocessor then sends information 112 to the shuttered eyewear 10 and instructs the shuttered eyewear 10 to open the right eye shutter 12a. The process is then repeated for the next set of images.

In one embodiment, the microprocessor 520 may also send information 112 that includes instructions to close either the left eye shutter 12b or the right eye shutter 12a, however, in a preferred embodiment, the shuttered eyewear 10 keeps the shutters open for a specified period of time and then automatically closes them. If the shuttered eyewear 10 automatically closes the shutters, communication traffic between the microprocessor 520 and the shuttered eyewear 10 is reduced.

As shown in the embodiment of FIG. 5, the shuttered eyewear 10 may also send feedback information 114 back to the microprocessor 520. The feedback information 114 may be sent to the microprocessor 520 via the display 510, may be sent directly to the microprocessor 520, or may be routed to the microprocessor 520 through other electronics.

The feedback information 114 contains data from the sensor(s) 16 about the actual response and light that passes through the right eye shutter 12a and the left eye shutter 12b. The microprocessor 520 uses this feedback information to adjust the synchronization of the display of the image and the command signal to control either the right eye shutter 12a or the left eye shutter 12b. By receiving feedback information 114 from the sensor(s) 16 on the shuttered eyewear 10, the microprocessor 520 may more precisely synchronize the stereoscopic system 500. Receiving the feedback information 114 and adjusting the synchronization signals within information 112, allows the microprocessor 520 to form a closed loop system and adjust the synchronization for the actual throughput of the system. This closed data loop allows the stereoscopic system 500 to make up for changes in response time, temperature, signal transmissions, transient states, or any other factor that may affect the synchronization, and thus performance, of the stereoscopic system 500.

Feedback information 114 is not required to be sent back to the microprocessor 520 as frequently as the information 112 is sent to the shuttered eyewear 10. While the frequency may be any frequency, in a preferred embodiment feedback information 114 may be collected and averaged over a number of cycles by the shuttered eyewear 10 before being sent to the microprocessor 520. Reducing the frequency at which the feedback information 114 is sent reduces transmissions. Furthermore, integrating the data from the sensor(s) 16 over a number of shutter cycles may give a more accurate result.

Similarly, the timing of when feedback information 114 is sent back to the microprocessor 520 is not critical. Feedback information 114 may be sent by the shuttered eyewear 10 at anytime throughout the process. Preferably, the feedback information 114 is sent on a periodic basis so that the microprocessor 520 may periodically update the synchronization of the stereoscopic system 500.

FIG. 6 illustrates an embodiment of a synchronization signal 600 received by shuttered eyewear 10. The synchronization signal 600 may be included within the information 112 received by shuttered eyewear 10. Moreover, the information 112 may include other data in addition to the synchronization signal 600.

In one embodiment of a stereoscopic system as taught by the present patent document, feedback information 114 is used to modify the synchronization signal 600 to optimize synchronization between a display and shuttered eyewear 10. Any portion of the synchronization signal 600 may be modified to better synchronize the display with the shuttered eyewear 10. For example the synchronization signal 600 may be modified by changing the frequency, the period, the spacing of the waves, the shape of the waveform or any other adjustment. These modifications and/or adjustments to the synchronization signal 600 are discussed in more detail below.

The synchronization signal 600 shown in FIG. 6 includes a leading edge 610 signaling the shuttered eyewear 10 to open the left eye shutter 12b and a leading edge 612 signaling the shuttered eyewear 10 to open the right eye shutter 12a. In addition, the synchronization signal 600 includes falling edges 611. The falling edges 611 may be used by the shuttered eyewear 10 to close the shutter that is currently open. However, as explained above, more preferably shuttered eyewear 10 is programmed to keep the left eye shutter 12b open for a time τ_{L} 616 and the right eye shutter 12a open for a time τ_{R} 618. Additional information that may be sent with the synchronization signal 600 in information 112 includes information related to the adjustment of the time the shutters remain open τ_{L} 616 and τ_{R} 618.

Although an exemplary embodiment of a waveform for a synchronization signal 600 is illustrated in FIG. 6, any type or shape of waveform may be used. Furthermore, although as described above reference is made to opening the shutters on a leading edge and closing the shutters on a falling edge, the waveform of the synchronization signal 600 may be mapped to the operation of the shuttered eyewear 10 in any appropriate fashion. For example, the falling edge instead of the leading edge may be used to signal the shutters on the shuttered eyewear 10 to open.

As may be seen in the waveform shown in FIG. 6, a period of time 614 exists between when one eye shutter is closing and the next eye shutter is opening. If the time period of 614 is made too small, cross-talk may occur. However, because minimizing time period 614 increases brightness, it is beneficial for the performance of the system to minimize time period 614 without creating cross-talk. In an ideal system that operated instantaneously with no latency, the time period 614 would be just long enough for the display to switch the images from an image intended for the left eye to an image intended for the right eye. However, because of latency and other factors, time period 614 may be some time period longer than that needed to swap the images on the display. In addition, the ideal time period 614 may change as the system is operated.

Using feedback information 114 from the shuttered eyewear 10, the stereoscopic system may adjust the synchronization signal 600. The synchronization signal 600 may be adjusted temporally. For example, the leading and falling edges may move forward or backward in time relative to when the image on the display is switched from an image intended for the left eye to an image intended for the right eye. Adjusting the synchronization signal 600 forward or backward in time with respect to the image display allows the stereoscopic system to position the swapping of the image on the display in the most optimal spot to minimize cross-talk within time period 614. In an ideal system, the image would be swapped on the display exactly in the middle of time period 614. However, because of latency and other factors, the optimal spot within time period 614 to minimize cross-talk may not be the middle. For example, the eye shutter might transition from light to dark faster than it can transition from dark to light. Using feedback information 114 allows the stereoscopic system to optimize the synchronization of the shuttered eyewear 10 and swap the image on the display at the optimal time within time period 614 to reduce cross-talk.

In addition, the stereoscopic system may adjust the time periods the eye shutters are open τ_{L} 616 and τ_{R} 618. Adjusting the amount of time the eye shutters are open affects the brightness perceived by the user and/or the cross-talk. The longer the eye shutters remain open the smaller time period 614 becomes and the brighter the image will appear to the viewer. However, reducing the time period 614 has the potential to increase cross-talk. Using feedback information 114 allows the stereoscopic system to optimize the time the eye shutters are open τ_{L} 616 and τ_{R} 618 to maximize brightness and minimize cross-talk.

The stereoscopic system may also adjust the frequency of the synchronization signal 600. For example, the first leading edge 610 of the open left shutter may be spaced closer or farther apart in time from the second leading edge 610 of the open left shutter resulting in a change in overall frequency. In general, the frequency of the eye shutters will match the frequency of the left and right images being switch on the display and therefore, should not need adjusting often or in great magnitude. However, as the electronics of the stereoscopic system begin to warm up the response time may improve and consequently the frequency may be increased.

Stereoscopic systems may include multiple displays or multiple shuttered eyewear 10. In particular, multiple pairs of shuttered eyewear 10 may view the same display in a single stereoscopic system. In a system including multiple pairs of shuttered eyewear 10 and a single display, the various different pairs of shuttered eyewear 10 may be controlled in a number of different ways. For example, the display could send an individual synchronization signal to each pair of shuttered eyewear 10. The information 112 received by the shuttered eyewear 10 may include an identification (ID) that the shuttered eyewear matches to its own internal ID to determine whether to sync to that particular synchronization signal 600.

In another embodiment, the different pairs of shuttered eyewear 10 (“Slaves”) are all calibrated to a single pair of shuttered eyewear 10 (“Master”) within the stereoscopic system. The various synchronization parameters of the Slaves are calibrated with an offset to the Master. The stereoscopic system may then send out a single synchronization signal to all the shuttered eyewear both Master and Slaves. The synchronization signal may subsequently be modified to optimize the Master. The Slaves continue to operate from the optimized signal including their respective offsets thus optimizing both the Master and the Slaves with a single synchronization signal 600. Other methods of synchronizing multiple pairs of shuttered eyewear to a single display may be used.

As part of the synchronization process, a test image or test image sequence may be used to synchronize the shuttered eyewear 10 with the stereoscopic system. The test images may be used as part of an initial calibration process or may be periodically used. One example of a test image sequence is showing an all white screen on the display intended for viewing by the left eye and all dark screen on the display intended for the right eye. The synchronization signal 600 may then be modified such that the sensor(s) 16 monitoring the throughput of light from the left eye shutter is at a maximum reading and the sensor(s) 16 monitoring the throughput of light from the right eye shutter is at a minimum reading. As a further calibration step, the eye intended to view the light and dark images may be swapped and the synchronization signal 600 may then be modified such that the sensor(s) 16 monitoring the light throughput from the left eye shutter is at a minimum reading and the sensor(s) 16 monitoring the light throughput from the right eye shutter is at a maximum reading. The above light and dark image sequence is just one example of a test image sequence that may be used and any image or sequence or images may be used to synchronize the shuttered eyewear 10 and the stereoscopic system.

Calibration of the shuttered eyewear using a test image or test sequence may happen prior to a user starting to view the display, prior to the start of three-dimensional content, during a scene transition, or on the fly. For example, calibration of the shuttered eyewear 10 by the stereoscopic system may be performed upon startup and before any content is displayed. As another example, calibration may occur during the brief pause between a program and a commercial. During the brief pause, the stereoscopic system may insert a few frames or more of test sequence images to recalibrate the shuttered eyewear 10. As another example, calibration may happen between scenes of the same movie or program. In some embodiments, combinations of the above calibration techniques may be used.

While numerous embodiments of the present patent document use transmitted feedback information 114 to allow the stereoscopic system to adjust the synchronization signal 600 being sent to the shuttered eyewear 10, transmitting feedback information 114 is not required. In one embodiment of the present patent document, the shuttered eyewear 10 may precisely synchronize with the stereoscopic system without transmitting feedback information 114. Rather than transmitting feedback information 114, back to the display or microprocessor to subsequently adjust the synchronization, shuttered eyewear 10 may automatically calibrate to the display. For example, synchronization signal 600 may only be received by the shuttered eyewear 10 as a reference signal and the shuttered eyewear 10 may use the feedback information 114 internally to adjust the timing of the eye shutters relative to the synchronization signal 600. In such an embodiment, the shuttered eyewear 10 does not need to transmit feedback information 114. An embodiment that does not require the transmission of the feedback information 114 is especially useful for retrofitting existing systems that do not have the capability to transmit information.

In embodiments where the shuttered eyewear 10 synchronizes to the stereoscopic system without transmitting feedback information 114, information 112 sent to the shuttered eyewear 10 may further include data instructing the shuttered eyewear 10 when a calibration image sequence will be displayed and the type of calibration imaged sequence that will be displayed. In other embodiments, the shuttered eyewear 10 may be preprogrammed with the calibration sequence image information and therefore, be able to automatically calibrate with the stereoscopic system.

A further advantage of having access to feedback information 114 from the sensor(s) 16, is the ability to coast through periods when communication may be lost with the rest of the stereoscopic system. Due to interference or other reasons, the shuttered eyewear 10 may temporarily cease receiving information 112 from the stereoscopic system. Feedback information 114 may be used by the shuttered eyewear 10 to continue to operate the eye shutters in sync with the display. Because feedback information 114 may be useful locally as well as when transmitted, embodiments of the present patent document may both retain feedback information locally within shuttered eyewear 10 and transmit feedback information 114.

FIG. 7 illustrates a pair of shuttered eyewear mounted in a calibration docking station. In embodiments such as the one shown in FIG. 7, shuttered eyewear 10 may not have a sensor 16 mounted to the frame of the shuttered eyewear 10. Rather, the shuttered eyewear 10 is placed in a calibration docking station 700 for calibration. Calibration docking station 700 is in communication with the stereoscopic system (not shown). For example, the calibration docking station 700 may be connected to the stereoscopic system via a USB cable, Ethernet cable, firewire cable, or wireless link. To calibrate the shuttered eyewear 10, the calibration docking station 700 uses a light or image producing flash 720. The flash 720 projects a test image or sequence of images while the eye shutters of the shuttered eyewear 10 are synchronized. The calibration sensor 710 collects the data related to the light and/or image throughput and feeds it back to the stereoscopic system so that the operation of the eye shutters may be optimized and synchronized. Once the shuttered eyewear 10 is synchronized in the calibration docking station 700, the shuttered eyewear 10 may be removed and used for viewing the display.

While the embodiment shown in FIG. 7 for use with a calibration docking station 700 shows the calibration sensor 710 mounted to the calibration docking station 700, the shuttered eyewear 10 may still have its own sensor(s) 16 mounted to the frame. The sensor(s) 16 may be in addition to the calibration sensor 710 or the sensor(s) 16 may be used instead of the calibration sensor 710.

In other embodiments taught by present patent document, the shuttered eyewear 10 may further include buttons or knobs to assist with synchronization or calibration. For example, the shuttered eyewear 10 may include a calibration button. When the user presses the calibration button the system sends a test image or test image sequence to recalibrate and/or synchronize the shuttered eyewear 10.

In another embodiment, the shuttered eyewear 10 may further contain buttons or knobs to allow manual adjustment of the eye shutter speed, frequency, response, open time, or any other characteristic of the eye shutters. For example, a full turn of a knob located on the shuttered eyewear 10 may equate to a quarter wave length latency in one or both of the eye shutter opening times. This adjustment may be in addition to the automatic synchronization and/or calibration or may be the only method of adjustment. When the manual adjustment is used in conjunction with the automatic adjustment, the manual adjustment may be an offset from the nominal synchronization calculated by the automatic adjustment.

In addition, in certain embodiments, the manual controls such as buttons and knobs are not located on the shuttered eyewear 10 but are located on other parts of the stereoscopic system such as the display. In other embodiments in which an external computer may be controlling the display, the manual adjustment may be located on the external computer or within software running on the external computer.

Although the invention has been described with reference to preferred embodiments and specific examples, it will readily be appreciated by those skilled in the art that many modifications and adaptations of the methods, stereoscopic systems and shuttered eyewear described herein are possible without departure from the spirit and scope of the invention as claimed hereinafter. Thus, it is to be clearly understood that this description is made only by way of example and not as a limitation on the scope of the invention as claimed below.

What is claimed is:

1. Shuttered eyewear comprising:
a frame;
a right eye shutter supported by the frame;
a left eye shutter supported by the frame; and
a sensor arranged to detect light passing through the right eye shutter, the left eye shutter, or both.

2. The shuttered eyewear according to claim 1, further comprising a transmitter.

3. The shuttered eyewear according to claim 2, wherein the transmitter is designed to transmit information about detected light passing through the right eye shutter, the left eye shutter, or both.

4. The shuttered eyewear according to claim 1, wherein a right eye shutter, the left eye shutter, or both is modified based on information from the sensor.

5. The shuttered eyewear according to claim 1, wherein the sensor is connected to the frame on a proximal side with respect to the face.

6. The shuttered eyewear according to claim 5, wherein the sensor is oriented to detect light without reflection passing through either the left eye shutter or the right eye shutter.

7. The shuttered eyewear according to claim 5, wherein the sensor is oriented to detect light reflected from an eyeball of a person wearing the shuttered eyewear.

8. The shuttered eyewear according to claim 1, wherein the sensor is a photo diode.

9. The shuttered eyewear according to claim 1, wherein the shuttered eyewear is designed to be synchronized using a calibration image.

10. A system for stereoscopic viewing, the system comprising:
a display; and
a shuttered eyewear designed to detect an amount of light from the display that passes through the shuttered eyewear.

11. The system according to claim 10, wherein information from the detected light that passes through the shuttered eyewear is used to synchronize the display and the shuttered eyewear.

12. The system according to claim 11, wherein the information is transmitted from the shuttered eyewear to the display.

13. The system according to claim 11, wherein the shuttered eyewear includes a sensor mounted to the shuttered eyewear and used to detect the light that passes through the shuttered eyewear.

14. The system according to claim 11, wherein the synchronization is controlled by a microprocessor.

15. A method of operating shuttered eyewear, the method comprising the steps of:
opening a first eye shutter;
closing a first eye shutter;
opening a second eye shutter;
closing a second eye shutter; and
sensing light passing through either the first eye shutter, the second eye shutter, or both.

16. The method of operating shuttered eyewear according to claim 15, further comprising the step of using information from the sensed light to synchronize the left eye shutter, the right eye shutter, or both.

17. The method of operating shuttered eyewear according to claim 15, further comprising the step of transmitting information about the sensed light from the shuttered eyewear to the display.

18. The method of operating shuttered eyewear according to claim 15, wherein the sensing light step occurs while the shuttered eyewear are within a calibration station.

19. The method of operating a shuttered eyewear according to claim 15, wherein the sensed light originates from a calibration image.

20. The method of operating a shuttered eyewear according to claim 16, wherein the left eye shutter, right eye shutter, or both are synchronized through the additional step of sending a modified synchronization signal from a display to the shuttered eyewear.
